(19) United States
(12) Patent Application Publication
(10) Pub. No.: US 2011/0105661 A1
(43) Pub. Date: May 5, 2011

(54) WATER-IN-OIL POLYMER EMULSIONS

(75) Inventor: Igor Aksman, Wynnewood, PA (US)

(73) Assignee: CRODA INC., EDISON (NJ)

(21) Appl. No.: 12/737,104

(22) PCT Filed: Jun. 8, 2009
(86) PCT No.: PCT/US2009/003447

§ 371 Date: Dec. 8, 2010

(51) Int. Cl. C08K 5/205; C08K 5/21

(52) U.S. Cl. 524/199; 524/215

(57) ABSTRACT

Inverse emulsions have a discontinuous internal phase of an aqueous solution of water soluble polymer and a continuous external phase of a stabilised oil system of an oil and an oligomeric stabiliser including urethane and/or urea linkages and residues of a fatty acid dimer and/or trimer component. The stabiliser is particularly either dimer based with units of the formula (I): —(X)-(D)-(X)CO—NH—R¹— (I); where -(D)- is a difunctional dimer residue; each X is —O— or —NH—; and R¹ is C₁ to C₆₀ hydrocarbylene, or trimer based with units of the formula (III): —(X′)₂-(T)-(X′)CO—NH—R¹⁰— (III) where -(T)- is a trifunctional trimer residue; each X′ is —O— or —NH—; and R¹⁰ is as defined for R¹.

### CROSS REFERENCE TO RELATED APPLICATION

This application claims the benefit of priority from U.S. Provisional Application No. 61/129,196, filed Jun. 10, 2008. This application, in its entirety, is incorporated herein by reference.

This invention relates to inverse (water-in-oil) emulsions in which the aqueous internal phase is a solution of a water soluble polymer and particularly to the stabilisation of such polymer emulsions against settling and phase separation, in particular by including oil soluble oligomeric stabiliser in the emulsion.

Water-in-oil emulsions of water soluble polymers are well known materials and are, for example, described in U.S. Pat. No. 3,284,393 (Vanderhoff et al), U.S. Pat. No. 3,624,019 (Anderson et an and U.S. Pat. No. 3,734,873 (Anderson et al). Such inverse emulsions are used to ease handling of water soluble polymers which have a marked, particularly thickening, effect on the rheology of the aqueous solution. Using inverse emulsions may make it simpler and easier to produce an aqueous solution at a specific desired concentration and/or to synthesise the polymer in water starting with monomer(s). A known problem with inverse (water-in-oil) polymer emulsions is that they are not as storage stabile as is desirable. Over time, density differences between emulsion components leads to either or both droplets containing water soluble polymer settling out of the emulsion and possibly agglomerating as a lower layer, or a separate layer of oil tends to phase separate at the upper surface of the emulsion. Such storage instability can lead to significant waste and difficulties in end user handling of the emulsions and improvements in emulsion stability are thus desirable.

This invention is based on the discovery that inverse polymer emulsions of water soluble polymers can be stabilised using oligomeric urethane and/or urea polymers including residues of dimer acid, dimer diol and/or dimer diamine.

Accordingly the present invention provides an inverse emulsion including a discontinuous internal phase comprising an aqueous solution of a water soluble polymer and a continuous external phase comprising a stabilised oil system which comprises an oil and including as a stabiliser an oligomer including urethane and/or urea linkages and residues of a dimer and/or trimer component.

The dimer based urethane and/or urea oligomers used to provide stability in inverse emulsions in this invention is [more fully] described in PCT published application WO 2007/135384 A as a structurant/thickener in agrochemical gel “oil flowable” formulations.

The inverse emulsions of the invention are stabilised using oligomeric urethane and/or urea polymers including residues of dimer acid, dimer diol and/or dimer diamine. The term “oligomeric stabiliser” used herein describes a, polymeric or oligomeric, material which enhances the stability of the inverse emulsions of the invention, and for convenience is used irrespective of the number of repeat units or molecular weight of the materials concerned. The oligomeric stabilisers used in this invention may have varying repeat units.

The oligomeric stabilisers act to increase the viscosity and provide structure to the oil continuous phase of the water in oil inverse emulsion and as a result, storage stability of the emulsions against settling and phase separation is significantly increased. The oil phase of the inverse emulsions of the invention may be described as “structured”, by which we mean that emulsion disperse phase droplets dispersed in a structured oil phase show a much lower tendency to cream, settle, segregate or separate from the oil continuous phase than in the absence of the structurant oligomeric stabiliser. We believe that the structure is provided by thickening or gelling the oil phase and it is usually possible to measure the yield stress of the gelled oils. The yield stress enables the gelled oil to provide support for the disperse phase thus stabilising the emulsions, with the disperse phase droplets showing a reduced tendency to cream, settle out, segregate or separate from the oil phase. It is possible (see further below) for the gel to be “amorphous” in which case it will not generally show a well defined yield stress, but it rheological properties provide improved dispersion of the disperse phase. Generally, the structured oil phase of the inverse emulsions of the invention show strongly shear thinning properties even at relatively low shear rates and this aids pouring or pumping of the inverse emulsions and, where appropriate, their inversion on dilution in water.

When the inverse emulsions of the invention uses oligomeric structurants which include a dimer component, the dimer component unit will usually include a unit of the formula (I):

—(X)-(D)-(X)CO—NH—R¹— (I)

where
-(D)- is a difunctional residue which is or includes fatty acid dimer residues;
each X is independently —O— or —NH—, though usually the X groups are either both —O— or both —NH—; and
R¹ is a C₁ to C₆₀, particularly a C₂ to C₄₄, hydrocarbylene group.

More usually, the oligomeric structurant compounds used in the invention include repeat units of the formula (Ia):

—(X)-(D)-(X)C(O)NH—R¹—NHC(O)— (Ia)

where D, R¹ and each (X) are independently as defined for formula (I).

In particular, repeat unit in the oligomers used in the invention can be urethane repeat units of the formula (Ib):

—O-(D)-OC(O)NH—R¹—NHC(O)— (Ib)

where D and R¹ are independently as defined for formula (I),
or urea repeat units of the formula (Ic):

—NH-(D)-NHC(O)NH—R¹—NHC(O)— (Ic)

where D and R¹ are independently as defined for formula (I).

Thus the overall oligomer can be of the formula (II):

R²—[(X)-(D)-(X)OCNH—R¹—NHCO]ₘ—(X)-(D)-(X)—R² (II)

where R¹, (X) and -(D)- are each independently as defined for formula (I);
each R² is independently H,
   a group —C(O)R³, where R³ is a hydrocarbyl group, particularly a C₁ to C₆₀, more usually a C₁ to C₄₄, especially alkyl, group, or
   a group —C(O)NH—R¹—NHC(O)—(X)—R⁴; or
   a group —C(O)NH—R⁴; or
the group —(X)R² is a group —O(AO)ₙ—(CO)ₚR⁴, where each OA is independently an ethyleneoxy or propyleneoxy group, n is from 1 to 50, p is 0 or 1;
   where each R¹ and X are independently as defined above and each R⁴ is independently a hydrocarbyl group, particularly a C₁ to C₆₀, more usually a C₁ to C₄₄, especially alkyl, group; and
m is from 1 to 25.

Within this formula, desirable polyurethane oligomers have the formula (IIa):

R^{2a}—(X^{a})—[(D^{a})—O₂CHN—R^{1a}—NHCO₂]ₘ₁-(D^{a})-(X^{a})—R^{2a} (IIa)

where
R^{1a} is independently as defined for R¹ in formula (I);
each -(D^{a})- is independently the residue of a diol which is or includes fatty acid dimer diol residues;
each R^{2a} is independently as defined for R² in formula (II);
each X^{a} is independently as defined for X in formula (II); and
m1 is an average value of from 1 to 25,
   and desirable polyurea oligomers have the formula (IIb):

R^{2b}—(X^{b})-[(D^{b})-NHCONH—R^{1b}—NHCONH—]ₘ₂-(D^{b})-(X^{b})—R^{2b} (IIb)

where
R^{1b} is independently as defined for R¹ in formula (I);
each -(D^{b})- is independently the residue of a diamine which is or includes fatty acid dimer diamine residues;
each R^{2b} is independently as defined for R² in formula (II);
each X^{b} is independently as defined for in formula (II); and
m2 is an average value of from 1 to 25.

When the inverse emulsions of the invention uses oligomeric structurants which include a trimer component, the trimer component will usually include a unit of the formula (III):

—(X′)₂-(T)-(X′)CO—NH—R¹⁰— (III)

where
-(T)- is a trifunctional residue which is or includes fatty acid trimer residues;
each X′ is independently —O— or —NH—, though within any component unit the X groups will usually be all either —O— or —NH—; and
R¹⁰ is independently a group as defined for R¹.

In particular trimer derived units within the formula (III) will be based on trimer triol and/or trimer triamine component units and the corresponding repeat units may be of the formula (IIIa):

—(X′)-(T)(X′R¹¹)—(X′)C(O)NH—R¹⁰—NHC(O)— (IIIa)

where T, R¹⁰ and each X′ are independently as defined for formula (III) and
R¹¹ is H, or (more usually) a group —C(O)NH—R¹², or a group —C(O)NH—R¹³—NHC(O)— (forming a third link as part of the repeat unit);
   where
   R¹² is a hydrocarbyl group, particularly a C₁ to C₆₀, more usually a C₁ to C₄₄, especially alkyl, group; and
   R¹³ is a group as defined for R¹⁰ in formula (III).

In particular, repeat unit in the oligomers used in the invention can be urethane repeat units of the formula (IIIb):

—O-(T)(OR¹¹)—OC(O)NH—R¹⁰—NHC(O)— (IIIb)

or urea repeat units of the formula (IIIc):

—NH-(T)(OR¹¹)—NHC(O)NH—R¹⁰—NHC(O)— (IIIc)

where T, R¹⁰ and R¹¹ are independently as defined for formula (III) or (IIIa).

Oligomers used in the invention may include both dimer containing and trimer containing units (see also below on the dimer/trimer source materials).

The dimer and/or trimer units in the structurants used in the invention may be provided as residues of dimer and/or trimer acids respectively reacted with hydroxyl or amine ended oligourethane or oligourea units, for example as the products of chain extension reactions. In such cases dimer component units may be of the formula (IV):

—(OC)-(D′)-(COX″)—R²⁰— (IV)

where
D′ is the residue of a dimer acid less the (two) carboxyl groups;
each X″ is independently —O— or —NH—, though within any component unit the X groups will usually be all either —O— or —NH—; and
R²⁰ is the residue of a urethane or urea oligomer,
   and dimer containing repeat units may be of the formula (IVa):

—(OC)-(D′)-(COX″)—R²⁰—(X″)— (IVa)

where D′, each X″ and R²⁰ are independently as defined for formula (IV).

Correspondingly trimer containing units may be of the formula (V):

—(X″C(O))₂-(T′)-(COX″)—R²⁰— (V)

where each X″ and R²⁰ are independently as defined for formula (IV) and T′ is the residue of a trimer acid less the (three) carboxyl groups,
and trimer containing repeat units may be of the formula (Va):

—(X″C(O))-(T′)(COX″R²¹)—(C(O)X″)R²⁰— (Va)

where D′, X″ and R²⁰ are as defined for formula (IV), and
R²¹ is H, or (more usually) a group —C(O)X″—R²², or a group —C(O)X″—R²³—X″C(O)— (forming a third link as part of the repeat unit);
   where each X″ is independently as defined for formula (IV);
   R²² is a hydrocarbyl group, particularly a C₁ to C₆₀, more usually a C₁ to C₄₄, especially alkyl, group; and
   R²³ is a group as defined for R¹⁰ in formula (III).

Although in such oligomers the oligourethane or oligourea units may include no such dimer or trimer residues, it is desirable that they do contain dimer and/or trimer residues (and will thus also fall within formula (II) or formula (IIIa) above).

The oligomers can include mixed urethane and urea repeat units either by using a mixture of hydroxyl—diol or triol—and amine—diamine or triamine—or by including a hydroxy amine in the synthesis (see further below) and the end group (where it is other than H) can be linked by ester, urea or urethane links depending on whether the oligomer is hydroxyl, amine or isocyanate ended and correspondingly by using an alcohol, amine, isocyanate or fatty acid (or suitably reactive derivative) to provide the end group functionality.

The groups -(D)- and -(T)- are respectively difunctional and trifunctional residues which is or includes residues based on fatty acid dimer and trimer residues. Fatty acid dimers and trimers (more commonly referred to simply as “dimer acids” or “trimer acids”) are the well known mainly dimeric or trimeric oligomerisation products derived from unsaturated fatty acids (industrially principally oleic, linoleic and/or linolenic acids), typically thermally oligomerised using clay catalysts. Generally they have average molecular weights corresponding to approximately two molecules or approximately three of the starting fatty acid, so dimerised oleic acid has an average molecular weight corresponding to a nominally C₃₆ diacid and trimerised oleic acid has an average molecular weight corresponding to a nominally C₅₄ triacid. As initially manufactured, dimer and trimer acids have unsaturation, typically corresponding to 1 or 2 ethylenic double bonds per molecule, but this may be reduced (hydrogenated) in making starting materials for the oligomers used in this invention.

The dimer derived starting materials will typically be either a dimer diol or a dimer diamine (or a mixture of these) (but see also below for description of chain extenders including dimer components). Dimer diols are the dihydroxy alcohols obtained by reducing or hydrogenating a dimer acid derivative, usually the methyl ester, to the dimer diol or by dimerisation of a corresponding unsaturated fatty alcohol. Dimer diamines are commercially made by nitrilation of the fatty acid e.g. with ammonia, followed by hydrogenation. For dimer derived residues, the group (D) will typically be either the residue of a dimer diol of the formula (IIIa) HO-(D)-OH, or a dimer diamine of the formula (IIIb) H₂N-(D)-NH₂, i.e. after removal of the diol hydroxyl or diamine amino groups. Hydroxyl ended dimer components may also be provided by using hydroxyl ended dimer acid oliogoesters with diols. Corresponding triol and triamine materials can be made from trimer acids by similar methods.

Dimer and trimer acids are commercially made as distillation fractions from the oligomerisation reaction described above and typically dimer acids will include small proportions of mono- and tri -carboxylic materials and trimer acids will include small proportions of mono- and di- carboxylic materials. The proportion of monofunctional material is desirably kept relatively low as such compounds will give will tend to act as chain stoppers in the urethane or urea oligomers. Generally the proportion of residues of such monofunctional hydroxyl or amino compounds in the material used to make the oligomer will not be more than about 6 wt %, more usually not more than about 3 wt %, and desirably not more than about 1 wt %, of the total diol or diamine residues used. Amounts from 0.5 to 3 wt %, more usually 1 to 2 wt %, of the total diol or diamine residues used are typical.

Trifunctional hydroxyl or amino compounds may be present in dimer acids and their derivatives used in this invention and such compounds will typically be incorporated into the oligomers and may give rise to branched oligomers. The proportion of residues of such trifunctional hydroxyl or amino compounds in the material used to make the oligomers used in the invention will not generally be more than about 80 wt %, more usually not more than about 25 wt %, and desirably not more than about 3 wt %, of the total diol or diamine residues used. Amounts from 0 to 2 wt %, of the total diol or diamine residues used are typical.

It will generally not be desirable in the inverse emulsions of the invention to use oligomeric stabilisers that are deliberately crosslinked to a major extent as this would be likely to reduce the flowability of the formulations. However, relatively low levels of cross-linking can give useful improvements in the gel properties of the oligomeric stabilisers, for example improved thermal stability, reduced bleeding (syneresis) in formulations, and better oil solubility. This can be achieved by adding tri- and/or higher functional monomer components as starting materials or by using excess diisocyanate in the polymer forming reaction; the excess diisocyanate can catalytically react to form allophanate (with urethane groups) and/or biuret (with urea groups) linkages. Suitable catalysts for this include stannous octanoate, potassium carbonate and triethylamine. However, excessive polymer cross-linking leads to undesirable thermal irreversibility, reduced oil or solvent solubility and poor physical handling properties. The amount of the cross-linking monomer(s) added (or excess diisocyanate used) will generally be relatively small, typically not more than about 10 mole % and desirably not more than about 3 wt %, of the total diol or diamine residues used.

Other difunctional compounds can be substituted for part of the dimer diol or diamine to modify the effect of the oligomer on the properties of the oil system, for example to vary the gel strength or improve the thermal stability i.e. increase the temperature at which the gel softens or melts.

Suitable such diols include alkane diols, e.g. 2 ethylhexane-1,3 diol, □□-alkane diols such as ethylene glycol, 1,3-propane diol and 1,4-butane diol, neopentyl glycol (2,2-dimethylpropane-1,3-diol), 1,6-hexane diol and 1,10-decane diol, polyalkylene glycols particularly those made using ethylene, propylene or butylene oxide, predominantly hydroxyl ended polyester polyol oligomers of dicarboxylic acids, such as adipic, azeleic, sebacic and dimer acids and their mixtures, and diols, such as those set out above (including dimer diols), partial fatty esters of polyols in which polyols such as glycerol, trimethylolpropane, sorbitol sorbitan, polyglycerol, pentaerithrytol and their alkoxylated versions, are esterified with fatty acids to give an average hydroxyl functionality close to 2, or such that two hydroxyl groups on the ester are substantially more reactive and fatty acids esters in which the fatty acids contributes hydroxyl functionality, such as glycol and polyol esters of ricinoleic acid, 12-hydroystearic acid and 9,10-dihyroxystearic acid. Diols from alkoxylation of ammonia, such as diethanolamine, or hydrocarbyl, particularly alkyl, especially fatty alkyl, amines such as laurylamine and diol derivatives of epoxidised oils and fats may also be used.

Using such polymeric diols it is possible to control the molecular weight and relative hydrophobicity of the diol so it can be chosen to be similar or different to the dimer diol units. This may enable more subtle adjustment of the structuring effect of the oligomer on the oil system. When used, such other diols will generally be from 1 to 75 wt %, more usually from 3 to 50 wt %, and desirably from 5 to 20 wt %, of the total diol residues used. Correspondingly the proportion of dimer diol residues used will generally be from 25 to 99 wt %, more usually from 50 to 97 wt %, and desirably from 80 to 95 wt %, of the total diol residues used.

Amines that can substitute for dimer diamine include hydrocarbyl diamines particularly alkylene diamines such as ethylenediamine, 1,2- and 1,3-diaminopropane, 1,4-diaminobutane, 1,2-diamino-2-methylpropane, 1,3- and 1,5-diaminopentane, 2,2-dimethyl-1,3-propanediamine, 1,6-hexane-diamine (hexamethylenediamine), 2-methyl-1,5-pentanediamine, 1,7-diaminoheptane, 1,8-diamino-octane, 2,5-dimethyl-2,5-hexanediamine, 1,9-diaminononane, 1,10-diaminodecane and 1,12-diaminododecane, cyclic hydrocarbyl amines such as 4,4′-methylenebis(cyclohexylamine), 1,3-cyclohexanebis(methylamine), adamantane diamine and 1,8-diamino-p-menthane, aromatic diamines such as 1,2-, 1,3- and/or 1,4-phenylene diamine, 2,4,6-trimethyl-1,3-phenylenediamine, 2,3,5,6-tetramethyl-1,4-phenylenediamine, xylene and naphthalene diamine (all isomers), diaminophenanthrene (all isomers, including 9,10), 2,7-diaminofluorene, diaminonaphthalene (all isomers, including 1,5; 1,8; and 2,3) and cyclic amines such as 4-amino-2,2,6,6-tetramethyl-piperidine. Such diamines may include hetero—e.g. oxygen, atoms particularly in alkyleneoxy residues. Examples of such materials include the so-called Jeffamine diamines (poly(alkyleneoxy)-diamines from Texaco). The diamines may include further nitrogen atoms as in polyalkylene amines, which are typically of the formula: NH₂—(CH₂CH₂NH)ₘCH₂CH₂—NH₂, where m is from 1 to about 5 and examples include diethylenetriamine and triethylenetetramine. The further nitrogen atoms may also be present as tertiary nitrogen atoms in particular as hetero-atoms in a cyclic group as in bis(aminoethyl)-N,N′-piperazine and bis(aminopropyl)-N,N′-piperazine. Such diamines may have one primary amine group and one secondary amine group as in N-ethylethylenediamine or 1-(2-aminoethyl)piperazine.

Generally when such modifying diamines are included the amounts will be relatively small as the diamines will react to give (bis)-urea linkages that will lead to stiffer chains and the polymers will usually have higher melting temperatures. When used, such other diamines will generally be from 1 to 20 wt %, more usually from 1 to 15 wt %, and desirably from 1 to 10 wt %, of the total diamine residues used. Correspondingly the proportion of dimer diamine residues used will generally be from 80 to 99 wt %, more usually from 85 to 99 wt %, and desirably from 90 to 99 wt %, of the total diamine residues used.

It is possible to include materials that provide both amino and hydroxyl functionality, which will generate both urethane and urea linkages in the product oligomer and examples include mono- and di-ethanolamine and propanolamine, 2-amino-2-methyl-1-propanol, 2-amino-1-butanol, 4-amino-1-butanol, 2-amino-2-ethyl-1,3-propanediol, AMPD (2-amino-2-methyl-1,3-propanediol), 2-amino-2-methyl-1,3-propanediol, and 2-amino-2-hydroxymethyl-1,3-propane-diol.

It is also possible, though not particularly desired to combine such other diols with dimer diamine and other amines with dimer diol to give mixed urethane/urea oligomers.

Tri- and higher functional hydroxyl and/or amino functional components can be included in the reagents used to make the structurant oligomers. Generally the proportions used will be small e.g. similar to the amounts of non-dimer amines (see above), and mono- or di-functional hydroxy or amino functional (or additional monocarboxylic functional) components may be included to act as chain stoppers to control the overall molecular weight and/or the extent of branching and/or crosslinking to avoid producing intractable and/or oil insoluble oligomers/polymers.

Chain extension reactions are briefly mentioned above as a way of making oligomeric structurants useful in the present invention, particularly by using multifunctional reagents to link together smaller oligomer units with possible subsequent reaction to end-cap the products. The chain extension reactions can form urethane/urea linkages, for example by reaction of hydroxyl/amine ended oligomer units with isocyanate chain extenders, or of isocyanate ended oligomer units with hydroxyl/amine ended chain extenders; or ester or amide linkages for example by reaction of hydroxyl/amine ended oligomer units with carboxyl ended chain extenders. The oligomer units used in this approach to the synthesis of oligomeric structurants, are urethane and/or urea linked oligomers made from suitable monomer materials such as those described above. The oligomer units can, and usually will, include dimer and/or trimer component residues, in which case the chain extender(s) can be di-, tri- or higher functional reagents which will typically be low molecular weight materials. In contrast, oligomer fragments which do not include dimer and/or trimer component residues may be used in which case the chain extender(s) will include dimer and/or trimer component residues e.g. using hydroxyl, amine, isocyanate or acid functional dimer or trimer compounds as appropriate. Of course, where the oligomer fragments do include dimer and/or trimer component residues, dimer or trimer based chain extender(s) may also be used.

Generally the proportion of chain extending agent will be chose to be appropriate to provide an oligomer product having a desired molecular weight, higher than that of the oligomer unit(s). The weight percentages will thus depend on the molecular weight of the oligomer units and of the chain extender. When trimer acid is used as the chain extender amounts of from 1 to 40%, more usually from 3 to 30%, particularly 5 to 20% by weight of the oligomer which is being chain extended, will be typical, with similar weight proportions for other trimer based chain extenders and corresponding amounts for chain extenders of different molecular weight and functionality. As with the tri- and higher functional hydroxyl and/or amino functional components mentioned above, mono-functional components may be included to act as chain stoppers to control the overall molecular weight and/or the extent of branching and/or crosslinking. End capping may be carried out after chain extension along the lines described above, though the inclusion of monofunctional components as chain stoppers many make separate end capping unnecessary. We have found that using trimer based chain extenders, particularly with dimer based oligomeric units can give structurants which give structured oils having a reduced tendency to “bleed” (syneresis) and good thermal stability.

The group R¹ in formula (II) and corresponding groups in other formulae, is a C₁ to C₆₀, more usually a C₂ to C₄₄, particularly a C₄ to C₃₆, especially a C₄ to C₂₄, hydrocarbylene group. Synthetically it can be considered as be the residue left after removal of an, and usually two, isocyanate groups from the (di-)isocyanate starting material (see below for oligomer synthesis). Suitable isocyanates include aromatic isocyanates, particularly diisocyanates e.g. phenyl diisocyanate, methylene bis-(4,4′)-phenyl isocyanate (also known as diphenylmethane-4,4′-diisocyanate or MDI), toluene diisocyanate (TDI), tetramethylxylene diisocyanate or derivatives and variants of such materials for example modified MDI; but more usually non-aromatic diisoycanates such as alicyclic isocyanates, particularly diisocyanates e.g. methylene bis-(4,4′)-cyclohexyl isocyanate (4,4′-dicyclohexylmethane diisocyanate), or isophorone diisocyanate; dimer diisocyanate; or, and particularly, alkylene isocyanates, particularly diisocyanates, more particularly C₂ to C₁₂, especially C₂ to C₈, and desirably C₂ to C₆ alkylene, diisocyanates, such as 2,2,4-trimethyl-1,6-hexamethylene diisocyanate; and desirably diisocyanates of the formula: OCN—(CH2)ₚ-NCO where p is from 2 to 12, more particularly from 2 to 8, and especially from 2 to 6 e.g. 1,12-dodecane diisocyanate or 1,6 hexamethylene isocyanate.

The groups R², in formula (II) and corresponding groups in other formulae, when other than H, provide end groups for the oligomer. Where the oligomers are end capped, the end cap groups, designated by —C(O)R³, —(X)—R⁴ in the group —C(O)NH—R¹—NHC(O)—(X)—R⁴, —C(O)NH—R⁴ and —O(AO)ₙ—(CO)ₚR⁴ in formula (II), can be acyl groups, as in R³C(O)—, or hydrocarbyl, as R⁴ in the group —(X)—R⁴, in the group —C(O)NH—R⁴ or in the group —C(O)NH—R⁴, (where —(X) —, R¹, R⁴, R⁵, AO, n and p are as defined in formula (II) above) the groups R³ or R⁴ are independently C₁ to C₆₀, more usually a C₁ to C₄₄, desirably a C₁ to C₂₄, hydrocarbyl, especially alkyl or alkenyl groups.

When the end cap group is a hydrocarbyl group (R⁴) it may be straight or branched chain, open chain or cyclic (including polycyclic), saturated or unsaturated group and is particularly an alkyl or alkenyl group such as stearyl, isostearyl, oleyl, cetyl, behenyl, e.g. as derived from the linear alcohols available under the commercial designations “Nafol” and “Nacol”, the mixtures of linear and branched chain alcohols commercially available as “Lials”; or as derived from Guerbet (branched chain) alcohols e.g. those commercially available under the “Isofol” commercial designations or a cyclic, particularly acyclic, group such as cyclohexyl, or a polycyclic group such as the residue or rosin alcohol for example as derived from Abitol-E from Eastman. Hydrocarbyl end caps can be linked to the oligomeric chain by —O— groups (giving a urethane link) or by —NH— groups (giving a urea link) and a terminal (bis-)isocyanate derived residue.

When R² is an acyl group the group R³ is usually a C₁ to C₅₉ group and more usually is a long chain particularly a C₇ to C₄₃ group, more particularly a C₉ to C₃₁ and especially a C₁₁ to C₂₃ hydrocarbyl group which may be straight or branched chain, open chain or cyclic (including polycyclic), saturated or unsaturated and is desirably an alkyl, alkenyl or alkadienyl group. In other words, R³ is part of an acyl group derived from the corresponding C₂ to C₆₀, particularly C₈ to C₄₄, more particularly a C₁₀ to C₃₂ and especially a C₁₂ to C₂₄, fatty acid. In particular the acyl group —C(O)R³ is derived from a C₈ to C₃₀ fatty acid, particularly lauric, stearic, isostearic, oleic or erucic acids. Other monofunctional acids that can be used include cyclic, particularly acyclic, e.g. polycyclic, acids such as abietic acid (rosin acid). Acyl end caps can be linked to the oligomeric chain by —O— groups (giving an ester link) or by —NH— groups (giving an amide link).

The oligomers used in this invention desirably have a number average molecular weight of from 1000 to 20000, more usually from 1500 to 10000 and particularly from 2000 to 8000. For compounds of the formula (II), this corresponds to (average) values for the index m, including the indices m1 and m2 in formulae (IIa) and (IIb) respectively, of typically from 1 to 20 more usually from 2 to 15 and particularly from 2 to 10 urethane dimer diol oligomer repeat units i.e. the value of the index m, per molecule. Similar numbers of repeat units will be typical for trimer based and other structurant oligomers used in the invention.

Although trifunctional starting materials may be used, when these are present care may be needed to avoid making insoluble or intractable oligomers arising from excessive crosslinking. At least to some extent, the average functionality can be controlled by including non-dimer difunctional reagents in a similar way to those described above with dimer derived OH or NH₂ functional materials and/or monofunctional regents e.g. monofunctional alcohols or amines, may be included as chain stoppers. We have made oligomers that are effective gelling agents using trimer triol as a starting material or by using trifunctional chain extenders such as trimer acid (see below) without having to include monofunctional chain stoppers.

The oligomers used in this invention, particular oligomers including repeat units based on dimer and trimer units as described above with reference to formulae (I) to (V) above can be made by generally conventional methods. At least notionally, the reactions can be considered as a first stage forming an intermediate oligomer and subsequently, if desired, reacting capping groups onto the intermediate oligomer. The intermediate oligomer can be hydroxyl (diol or triol) or amine (diamine or triamine) ended or isocyanate ended depending in particular on the molar ratio of the starting diol or amine and isocyanate (noting that isocyanate ended oligomers will not usually be left uncapped in view of the reactivity of isocyanate groups).

Thus polyurethanes of the formula (IIa) can be made by reacting a diol of the formula: HO-(D^{a})-OH, where -(D^{a})- is as defined in formula (IIa), with a suitable diisocyanate, particularly of the formula OCN—R¹—NCO, where R¹ is as defined for formula (I), under urethane polymerisation conditions, particularly in the presence of a urethane polymerisation catalyst (see also below), to form the intermediate oligomer. Corresponding reactions can be used to make trimer containing materials.

End caps may be reacted on depending on the groups at the end of the oligomer. Where the oligomer is isocyanate ended, reaction with an alcohol R²OH, where R² is as defined in formula (II), will give a R² substituted urethane ended oligomer and reaction with an amine R²NH₂, where R² is as defined in formula (II), will give a R² substituted urea ended oligomer. Where the oligomer is hydroxyl (diol) ended, the capping reaction may be with an alcohol of the formula: R²OH (or a reactive derivative), where R² is as defined in formula (II), under etherification conditions, particularly in the presence of an etherification catalyst such as potassium carbonate, potassium hydroxide, sodium hydroxide or stannnous octoate, or an acid of the formula R³COOH (or a reactive derivative), where R³ is as defined for formula (II), under esterification conditions, particularly in the presence of an esterification catalyst such as tetrabutyl titanate (TBT), tetra-isopropyl titanate (TIPT), stannous octoate e.g. the commercial product Tegokat 129, bases e.g. potassium or sodium carbonate, acids e.g. para-toluene sulphonic acid (PTSA), dodecyl benzene sulphonic acid (DBSA) or sulphuric acid, more particularly by reacting with an ester of the formula R³COOR⁵, where R³ is as defined for formula (II), and R⁵ is a lower, particularly C₁ to C₈, alkyl and especially a methyl, group under transesterification conditions, particularly in the presence of transesterification catalyst such as TBT, TIPT , stannous octoate, or a base e.g. potassium or sodium carbonate.

Similarly polyureas of the formula (IIb) can be made by reacting a dimer diamine of the formula H₂N-(D^{b})-NH₂, where -(D^{b})- is as defined in formula (IIb), with a suitable diisocyanate, particularly of the formula OCN—R¹—NCO where R¹ is as defined for formula (I), under polyurea polymerisation conditions, particularly in the presence of a polyurea polymerisation catalyst (see also below), to form the intermediate oligomer. Corresponding reactions can be used to make trimer containing materials.

End caps may be reacted on depending on the groups at the end of the oligomer. Where the oligomer is isocyanate ended, reaction with an alcohol R^{2b}OH, where R^{2b} is as defined in formula (IIb), will give a R^{2b} substituted urethane ended oligomer and reaction with an amine R^{2b}NH₂, where R^{2b} is as defined in formula (IIb), will give a R^{2b} substituted urea ended oligomer: Where the oligomer is amine (diamine) ended, the capping reaction may be with an acid of the formula R³COOH (or a reactive derivative), where R³ is as defined for formula (II), under amidation conditions, particularly in the presence of an amidation catalyst such as TBT, TIPT, E-cat (TiO₂ with small amounts of TiCl₄Ti(OH)₂ and TiCl₂), more particularly by reacting with an ester of the formula R³COOR⁵, where R³ is as defined for formula (II), and R⁵ is a lower, particularly C₁ to C₈, alkyl and especially a methyl, group under transamidation conditions, particularly in the presence of transamidation catalyst such as the amidation catalysts listed above.

From formula (II) the group R² used as an end cap may be the residue of a mono-alkyl or ester capped alkoxylate e.g. propylene glycol monoesters such as the isostearate, and the term “alcohol” for R²OH as used above is generic to include this as well as simple alcohols.

Catalysts for the urethane and urea reactions can be tertiary bases, e.g. bis-(N,N′-dimethylamino)-diethyl ether, dimethylaminocyclohexane, N,N-dimethylbenzyl amine, N-methyl morpholine, reaction products of dialkyl-(b-hydroxyethyl)-amine with monoisocyanates, esterification products of dialkyl-(b-hydroxyethyl)-amine and dicarboxylic acids, and 1,4-diaminobicyclo-(2.2.2)-octane, and non-basic substances such as metal compounds e.g. iron pentacarbonyl, iron acetyl acetonate, tin(II) (2-ethylhexoate), dibutyl tin dilaurate, molybdenum glycolate, stannous octoate, TBT and TIPT.

Generally where the intermediate oligomer is (or would be) hydroxy or amine ended, the reaction will generally be carried out in two stages, first formation of the intermediate oligomer and then capping the oligomer (if desired). Where the intermediate oligomer is (or would be) isocyanate ended, and particularly where the capping groups are hydroxyl compounds (alcohols) the reaction may be carried out in a single step by with all the reagents in a single vessel from the outset.

Where the synthesis includes chain extension reactions, these will usually be urethane or urea forming reactions (between isocyanate and hydroxyl or amine respectively) or ester or amide forming reactions (between carboxylic acid (or reactive derivative) and hydroxyl or amine respectively) and will be carried out under conditions described above for such reactions.

We have generally found it practical to carry out the synthetic reactions without solvent or diluent using the raw materials neat. In particular reagents such as monocarboxylic acid esters included as end capping reagents can act also as reaction diluents/solvents until they are reacted into the oligomers. However, it is possible to use solvents or diluents if desired to improve the ease of handling of the oligomer. Suitable solvents or diluents include acetone, toluene, plasticizer esters, other esters such as benzoates e.g. 2-ethylhexyl benzoate, or isopropyl esters such as ispropyl myristate, glyceride esters such as triglycerides e.g. glycerol trioleate, optionally (partial) esters of polyols, N-methylpyrrolidone, oils and carbonates.

Reactions with isocyanates, oligomerisation or capping reactions, are generally carried out at temperatures from 50 to 150° C., more usually 60 to 125° C. Reactions with acids or esters to form ester or amide end caps with acids are generally carried out at temperatures from 150 to 270° C., more usually 180 to 230° C., e.g. at about 225° C. For both direct and trans-esterification and amidation reactions can be carried out at ambient pressure or at moderate vacuum e.g. from 600 to 10 mBar (60 to 1 kPa) gauge will usually be used. Inert gas e.g. nitrogen, sparging may be used under ambient or reduced pressure to aid removal of volatiles from the reaction. Generally, a small excess of the acid or the ester (usually methyl ester) will be used.

A wide range of oils can be used as the continuous phase in the inverse emulsions of the invention. However, commonly the oils used in inverse emulsions are hydrocarbon oils e.g. naphthenic and/or paraffinic oils of petrochemical origin and/or ester oils e.g. as described in EP 0923611.

Typical oils that can be structured using compounds of the invention include:
hydrocarbons including (toluene, xylene,) and liquid paraffinic materials such as (hexane, octane, gasoline,) diesel, liquid hydrocarbon waxes, lamp oil, paraffinic oils such as Sunspray 6N, 8N and 11N (Sunoco) and Puccini 19P (Q8), (iso)-paraffinic oils such as Isopar V and Exxol D140 (ExxonMobil), and aromatic mineral oils such as the Solvesso brandalkyl benzenes (ExxonMobil);
ester oils particularly those based on C₂ to C₃₀ linear, branched or unsaturated fatty acids and linear, branched or unsaturated fatty alcohols, and typically esters derived from monocarboxylic acid(s) with monohydric alcohol(s); di- or tri-carboxylic acid(s) with monohydric alcohol(s); or di- or poly-hydric alcohol(s) with monocarboxylic acid(s), e.g. ester oils available from Croda and Uniqema: 2-ethylhexyl cocoate (Crodamol OC), 2-ethylhexyl stearate (Crodamol OS), 2-ethylhexyl palmitate (Crodamol OP), isporopyl palmitate (Crodamol IPP), isotridecyl isononanoate (Crodamol TN), PPG3 benzyl ether myristate (Crodamol STS), caprylic/capric triglyceride (Crodamol GTCC), di(myristyl PPG-3 ether) adipate (Cromollient DP3A), glycerol tris-2-ethylhexanoate ester oil (Estol 3609), isopropyl isostearate (Prisorine 2021), methyl oleate (Priolube 1400), and other esters such as methyl caprylate, alkyl acetate esters, particularly C₆ to C₁₃ alkyl acetates, and especially where the alkyl groups are oxo-alcohol residues, e.g. Exxate ester oils (Exxon), synthetic triglyceride esters such as glycerol tri-(C₈ to C₂₄)ates e.g. Estasan 3596 glycerol tricaprylate (Uniqema), Priolube 1435 glyceryl trioleate (Uniqema), and glycerol tri-ricinoleate, PEG oleate and isostearate, isopropyl laurate or isostearate, trimethylpropane triesters e.g. with mixed C₈/C₁₀, stearic or oleic acids; natural triglycerides such as rape seed (canola) oil, soya oil, sunflower oil and fish oil;
methylated natural triglycerides such as methylated rape seed, soya and/or sunflower oils;
aromatic ester oils, particularly esters if benzoic acid and C₈ to C₁₈ monohydric alcohol(s) e.g. Finsolve TN C₁₂ to C₁₅ benzoate oil (Finetex);

The oils, particularly as set out above can be used as mixtures of two or more different oils or types of oils.

The amount of the oligomeric stabiliser used is typically from 0.01 to 10%, more usually from 0.05 to 8% and especially from 0.1 to 5%, by weight based on the continuous oil phase. If desired the oligomeric stabiliser(s) may be used in combination with other structurant materials as stabilisers, particularly to ensure that the desired stabilising structurant effect it achieved across the entire temperature range required for any particular product. When used with other structurant stabilisers, the proportion of oligomeric stabiliser structurant will generally be from 25 to 95%, more usually from 40 to 80%, by weight of the total structurant stabiliser used. The total amount of structurant stabiliser when mixtures are used will generally be within the ranges given above for the compounds of the invention.

The oligomeric stabilisers will generally be incorporated into the oil used in the inverse emulsions of the invention by dissolving the stabiliser in the oil, usually at moderately elevated temperature typically from 50 to 140° C., more usually from 60 to 120° C., commonly from 80 to 110° C., and then cooling the mixture or allowing the mixture to cool to ambient temperature and structuring effects become apparent on cooling. We have found that the cooling rate can influence the properties of the stabilised (and structured) oil phase: rapid cooling, particularly “crash” cooling, results in a “softer” (and we believe more amorphous) structure and slow cooling gives a “stiffer” (and we believe more ordered, crystalline like) structure in the oil phase. Generally, thermal cycling below the melting point of the pure oligomer does not appear to influence the behaviour of the material and heating stabilised oil phases to above their melting temperature and re-cooling results in re-formation of the structrued oil phase.

Optionally but desirably, a plasticizer can be added to the oligomeric stabiliser to improve handling, particularly at or near ambient temperature and/or reduce melting temperature of the oligomer and/or and facilitate dissolution and activation of the oligomeric stabiliser in the oil phase of the inverse emulsion. The rheological properties of the stabilised (structured) oil phase can also be modified by addition of solvents and this can be used to modify the rheological properties of the inverse emulsions. Materials that can be used as plasticizers include compounds more generally known as surfactants, for example one or more alkoxylated fatty alcohols, particularly C₈ to C₂₀, more particularly C₁₀ to C₁₈, fatty alcohol 1 to 20, particularly 2 to 15, especially 3 to 12 alkoxylates, especially ethoxylates e.g. lauryl alcohol 4EO, oleyl alcohol 10EO and O_{12/15} alcohol 7EO; alkoxylated fatty amines, particularly C₈ to O₂₀, more particularly C₁₀ to O₁₈, fatty amine 2 to 30, particularly 5 to 30, alkoxylates, especially ethoxylates; alkoxylated fatty acids particularly C₈ to C₂₀, more particularly O₁₀ to C₁₈, fatty acid 1 to 20, particularly 2 to 15, especially 3 to 12 alkoxylates especially ethoxylates; partial esters, of sorbitan, sorbitol, glycerol and similar polyols e.g. e.g. sorbitan mono-oleate, mono-stearate and mono-laurate; fatty acid amides, particularly C₈ to O₂₀, more particularly O₁₀ to C₁₈, fatty acid amide surfactants, particularly alkanolamides such as ethanolamides, diethanolamides and propanolamides e.g. coconut fatty acid diethanolamide; anionic surfactants, particularly sulfosuccinates and phosphate esters and/or cationic surfactants such as imidazoline surfactants or quaternary fatty amine alkoxylates, generally N-fatty alkyl, N-lower alkyl, di(polyalkyleneoxy)quaternary amines usually as salts e.g. halide, particularly chloride or sulphate salts, particularly where the fatty alkyl group is a C₈ to O₂₀, more particularly C₁₀ to O₁₈, fatty alkyl, the lower alkyl group is a C₁ to O₄, particularly a methyl or ethyl, group, and the polyalkyleneoxy groups are 1 to 20, particularly 2 to 15, alkoxylates, especially ethoxylates (including generally a total of 5 to 30 alkyleneoxy groups); or mixtures of two or more types of these. The use of a surfactant, particularly a relatively high HLB surfactant, as the plasticizer may have the additional beneficial effect of boosting the inversion of the inverse emulsion on dilution in water and may allow for the complete or partial replacement of a deliberately added inverting surfactant.

The amount of plasticizer used is typically from 0.01 to 15%, more usually 0.05 to 10%, particulary 0.1 to 5%, by weight based on the oil phase.

As the main reason for including the plasticizer is to improve handling of the oligomeric stabiliser particularly when incorporating it in the oil, it is desirable to combine the oligomeric stabiliser component with the plasticizer prior to addition of the combination to the oil (usually before formation of the inverse polymer emulsion), although theoretically the plasticizer could be added to the oil phase separately from the oligomeric stabiliser. Mixing and homogenization of the oligomeric stabiliser and plasticizer is usually carried out at or modestly above the softening temperature of the oligomeric stabiliser, usually in the range 50° C. to 200° C., more usually from 50° C. to 150° C., and depends on melting and softening properties of the oligomeric stabiliser.

The addition of the oligomeric stabiliser and (optionally) plasticizer to the inverse emulson should not interfere with intended end use of the inverse emulson. Typically this involves inversion of the inverse emulsion on dilution in water and simple and efficient (in terms of the availability of the water soluble polymer) inversion of inverse emulsions is highly desirable. The oligomeric stabiliser and plasticizer are selected for compatibility with any particular inverse emulsion, in particular to avoid polymer coagulation caused by destabilisation of the inverse emulsion in which they are used so as to retain invertability and other desirable handling characteristics, particularly pourability and pumpability of the inverse emulsions.

The formulations may include other components such as dispersants, electrolytes, wetters and similar materials that are commonly included in inverse emulsion systems. The stabilised inverse emulsion formulations may include other components commonly included in such formulations such as surfactants, electrolytes and wetters.

Surfactants are commonly included in inverse emulsions in particular to aid dispersion of the disperse phase in the oil; and incorporate emulsifier to promote ready inversion and emulsification of the oil phase on dilution with water to invert the emulsion (with the water soluble polymer in the internal phase being dissolved and diluted in the water). Examples of these may include emulsifying agents as described in U.S. Pat. No. 3,284,393, and inverting surfactants as described in U.S. Pat. No. 3,624,019.

The external oil phase of the inverse emulsions of the invention are structured typically to provide dispersion stability desirably without making the inverse emulsion so viscous that mixing of the oil based formulation particularly with water to invert the emulsion becomes difficult. Mixing difficulties can arise in two ways, if the oil based formulation is sufficiently viscous that removing it from its storage container becomes difficult or that its viscosity makes mixing with the dilution water slow or inefficient. This means that the desirable rheology for the structured inverse emulsions of the invention is gelatinous or sufficiently viscous but which is readily shear thinning so that it readily becomes pourable and/or pumpable, but which is structured so as to provide improved stability of the inverse emulsion. Generally the inverse emulsions of the invention have a viscosity at low shear of from 250 mPa·s to about 10000 mPa·s and thin down at higher shear so that the viscosity of the formulation during mixing and pumping reduces to typically in the range 150 mPa·s to about 3000 mPA·s. The specific viscosity of any particular emulsion will depend on the oligomeric stabiliser concentration used and the particular properties of the stabiliser in the oil continuous phase.

It is desirable that the inverse emulsions of the invention should remain stable at ambient temperature for at least 1 month and at elevated temperatures typically up to at least 40° C. and desirably up to 50° C., for at least 2 weeks and at subambient temperatures usually at least as low as 0° C. and more usually down to −10° C. and desirably as low as −17.7° C. (0° F.) for up to eight weeks. These performance requirements are desirably also met when the formulations include surfactants, and solvents (when present) as well as the aqueous internal phase. It is also desirable to have freeze thaw stability over at least 3 test cycles.

The invention can be used to increase stability against aging of inverse emulsions of various synthetic and naturally occurring water soluble polymers. These polymers are well known to the art and have been widely described. Examples of polymers most commonly used include homopolymers and co-polymers of acrylamide, homopolymers and co-polymers of acrylic acid, acrylic acids salts, 2-acrylamido-2-methylpropane sulfonic acid and other ethylenically unsaturated monomers for preparing polyelectrolytes, various copolymers that include cationic monomers such as allyl amine, or dimethylaminoethylmethacrylate, and other ethylenically unsaturated monomers. Preparation of such polymers is described in U.S. Pat. No. 3,284,393.

The concentration of the water soluble polymer in the internal aqueous phase is typically from 20 to 70%, particularly from 30 to 50%, by weight of the internal phase. The internal phase typically forms from 30 to 75%, particularly from 50 to 70%, by volume of the overall emulsion.

Typically, these water soluble polymers are useful because of they provide effective thickening and/or flocculating properties in aqueous systems and find extensive commercial use in applications such as thickening and clarification of aqueous solutions, particularly in water purification applications including the treatment of sewage and industrial wastes; in paper making operations; as stabilizers for drilling muds, and secondary recovery of petroleum by waterflooding and to impart thickening, emulsifying, conditioning, and other desirable properties to hair care and skin care applications for personal products.

### EXAMPLES

The following examples illustrate the invention. All parts and precentages are by weight unless otherwise stated.

### Materials

IPE1 an inverse polymer emulsion comprising a continuous oil phase of a commercial naphthenic/paraffinic hydrocarbon liquid and a disperse phase of a 35 wt % aqueous solution of an acrylamide: dimethyl aminoethyl methacrylate copolymer (75:25 by wt), using sorbitan mono-oleate as emulsifier prepared broadly as described in Example 5 of U.S. Pat. No. 3,284,393.

PL1 polyoxyethylene (4) lauryl ether, Brij 30 ex Croda

PL2 fatty alcohol polyoxyethylene (7) ether, Synperonic A7 ex Croda

PL3 polyoxyethylene (10) oleyl ether, Brij 97 ex Croda

PL4 cocamide diethanol amine, Incromide CA ex Croda

OS1 an oligomeric stabiliser made as described in Synthesis Example SE1

### Test Methods

Viscosity—the viscosities of structured inverse emulsions and inverted emulsions made from them were measured using a Brookfield DV-II digital viscometer and the results are given in mPas (1 mPAs=1 cps).

Invertability—the ease and efficiency of invertion of structured inverse emulsions was tested by adding 2 g of the structured inverse emulsion to 300 g of distilled water at ambient temperature under vigorous agitation. The viscosity of the resulting aqueous solution was measured at 5, 10 and 15 minutes after inversion.

Aging stability—the aging stability of thickened emulsions was assessed by storing samples of structured inverse emulsion in wide test tubes. The amount of any measuring separated oil layer at the top of the inverse emulsion and of any sedimented layer at the bottom of the tube was measured and the results are expressed as percent by volume and recorded as oil (%) and sed (%) respectively.

### Synthesis Example SE1

### Preparation of an Ester-Terminated Oligourethane Stabiliser (OS1)

Dimer diol (Pripol 2033 ex Uniqema) (346.2 g; 0.638 mol), hexane diol (27.1 g; 0.229 mol) and isostearic acid (ex Uniqema) (106.5 g; 0.366 mol) were charged to a 21 flanged flask (“reactor”) equipped with an external electrical heater, nitrogen inlet, thermometer, condenser and receiving vessel, central stirrer and addition port. The mixture was heated under an inert nitrogen atmosphere (maintained throughout the reaction) to ca. 60° C. and stannous octoate (400 μl) as catalyst was then added. On completion of the exterification reaction, hexamethylene diisocyanate (Desmodur H ex Bayer) (100.5 g; 1.125 mol) was added through the addition port using a dosing pump at a rate of 150 g.h⁻¹.kg⁻¹. During this addition the temperature rose because of the exothermic reaction between the diols and diisocyanate. On completion of the diisocyanate addition, the mixture was rapidly heated to 225° C., and the mixture held at 225° C. until the hydroxyl value fell to 10 mg(KOH).g⁻¹ (or less). The reaction mixture was allowed to cool to 140-150° C. under nitrogen sparge and the product discharged and allowed to cool to ambient temperature to yield the oligomer as a slightly yellow hazy waxy solid.

### Plasticized Blend Formulations

Blends of the product of SE1 were made up with various plasticizers. The oligomeric stabiliser/plasticizer blend was made by mixing of 1 gram of OS1 with 2.5 g of plasticizer at 100° C. (above the polymer melting temperature—in the presence of the plasticizer).

| Blend No | Structurant | Plasticiser |
|---|---|---|
| Blend 1 | OS1 | PL1 |
| Blend 2 | OS1 | PL2 |
| Blend 3 | OS1 | PL3 |
| Blend 4 | OS1 | PL4 |

### Structured Inverse Emulsions

Structured Polymer emulsions were made by mixing the Blends 1 to 4 into polymer emulsion IPE1.

The homogeneous mixture (plasiticizer+PT1) was subsequently added to the IPE1 to obtain targeted concentrations of polymeric component in PE.

### Applications Examples

### Applications Example 1 Testing of Polymer Emulsions

The oligomeric stabiliser (OS1) as blended with plasticizer, was added under moderate agitation to IPE1 at ambient temperature, the viscosity of the resulting structured inverse emulsions was measured, the inverse emulsions inverted into water as described above and the viscosity of the inverted emulsions measured. The results of these inversion tests are set out in Table 1 below.

TABLE 1

| | Structurant | | Viscosity (mPas) | | | |
|---|---|---|---|---|---|---|
| | Blend | | Inverse | Inverted emulsions | | |
| Ex No | type | (%) | Emulsion | 5 m | 10 m | 15 m |
| AE1.C | none | — | 1400 | 3200 | 3250 | 3300 |
| AE1.1 | Blend 1 | 0.5 | 5200 | 3500 | 3350 | 3250 |
| AE1.2 | Blend 2 | 0.5 | 5500 | 3650 | 3450 | 3400 |
| AE1.3 | Blend 3 | 0.5 | 4400 | 4050 | 3650 | 3550 |
| AE1.4 | Blend 4 | 0.5 | 4700 | 3250 | 3150 | 3150 |

These data in Table 1 show that the ease and efficiency of invertsion of the inverse polymer emulsion is not adversely affected by the presence of the structurant polymer blends.

### Application Example 2

The stability of stabilised inverse polymer emulsions was tested using the aging test described above and the results are set out in Table 2 below.

TABLE 2

| | | | Aging | | | | | |
|---|---|---|---|---|---|---|---|---|
| | Structurant | | 7 days | | 10 days | | 14 days | |
| | Blend | | oil | sed | oil | sed | oil | sed |
| AE No | type | (%) | (%) | (%) | (%) | (%) | (%) | (%) |
| AE2.C1 | None | — | 3.13 | 2.1 | 4.69 | 3.4 | 6.25 | 4.2 |
| AE2.1a | Blend 1 | 0.5 | 0 | 0 | 0 | 0 | 2.66 | 0 |
| AE2.1b | | 0.25 | 1 | 0 | 2.33 | 0 | 3.49 | 1 |
| AE2.1c | | 0.125 | 2.56 | 0 | 2.38 | 0 | 3.75 | 1.2 |
| AE2.2a | Blend 2 | 0.5 | 0 | 0 | 0 | 0 | 0 | 0 |
| AE2.2b | | 0.25 | 1.16 | 0 | 2.33 | 0 | 2.33 | 0 |
| AE2.2c | | 0.125 | 2.38 | 0 | 3.49 | 1 | 3.57 | 1 |
| AE2.3a | Blend 3 | 0.5 | 0 | 0 | 0 | 0 | 0 | 0 |
| AE2.3b | | 0.25 | 0 | 0 | 1.16 | 0 | 2.27 | 0 |
| AE2.3c | | 0.125 | 2.38 | 0 | 2.33 | 0 | 2.4 | 1 |
| AE2.4 | Blend 4 | 0.5 | 0 | 0 | 0 | 0 | 0 | 0 |

These data show that the separation of a top oil layer and lower sediment layer on aging of structured inverse polymer emulsion noticeably reduced.

1. An inverse emulsion including a discontinuous internal phase comprising an aqueous solution of a water soluble polymer and a continuous external phase comprising a stabilised oil system which comprises an oil and including as a stabiliser an oligomer including urethane and/or urea linkages and residues of a dimer and/or trimer component.

2. An emulsion as claimed in claim 1 in which the oligomeric stabiliser includes a dimer component including units of the formula (I):
—(X)-(D)-(X)CO—NH—R¹— (I)
where
-(D)- is a difunctional residue which is or includes fatty acid dimer residues; each X is independently —O— or —NH—; and
R¹ is a C—₁ to C₆₀, particularly a C₂ to C₄₄, hydrocarbylene group, and/or the oligomeric stabiliser includes a trimer component including units of the formula (III):
—(X′)2-(T)-(X′)CO—NH—R¹⁰— (III)
where
-(T)- is a trifunctional residue which is or includes fatty acid trimer residues; each X′ is independently —O— or —NH—; and
R¹⁰ is independently a group as defined for R¹.

3. An emulsion as claimed in claim 2 in which the oligomeric stabiliser includes a dimer component in which the oligomer repeat group is of the formula (Ia):
—(X)-(D)-(X)C(O)NH—R¹—NHC(O)— (Ia)
where
D, R¹ and each (X) are independently as defined for formula (I).

4. An emulsion as claimed in claim 3 in which the oligomer includes urethane repeat units of the formula (Ib):
—O-(D)-OC(O)NH—R¹—NHC(O)— (Ib)
where D and R¹ are independently as defined for formula (I),
and/or urea repeat units of the formula (Ic):
—NH-(D)-NHC(O)NH—R¹—NHC(O)— (Ic)
where D and R¹ are independently as defined for formula (I).

5. An emulsion as claimed in claim 2 in which the oligomeric stabiliser includes a trimer trimer triol and/or trimer triamine component units and the corresponding repeat units may be of the formula (IIIa):
—(X′)-(T)(X¹R¹¹)—(X′)C(O)NH—R¹⁰—NHC(O)— (IIIa)
where T, R¹⁰ and each X′ are independently as defined for formula (III); and
R¹¹ is H, or (more usually) a group —C(O)NH—R¹², or a group —C(O)NH—R¹³—NHC(O)—
where
R¹² is a hydrocarbyl group, particularly a C—₁ to C₆₀, more usually a C—₁ to C₄₄, especially alkyl, group; and
R¹³ is a group as defined for R¹⁰ in formula (III).

6. An emulsion as claimed in claim 5 in which the oligomer includes urethane repeat units of the formula (IIIb):
—O-(T)(OR¹¹)—OC(O)NH—R¹⁰—NHC(O)— (IIIb)
or urea repeat units of the formula (IIIc):
—NH-(T)(OR¹¹)—NHC(O)NH—R¹⁰—NHC(O)— (IIIc)
where T, R¹⁰ and R¹¹ are independently as defined for formula (III) or (IIIa).

7. An emulsion as claimed in claim 1 wherein the amount of oligomeric stabiliser in the emulsion is from 0.01 to 10%, more usually from 0.05 to 8% and especially from 0.1 to 5%, by weight based on the continuous oil phase.

8. An emulsion as claimed in claim 1 in which the oligomeric stabiliser is used in combination with a plasticizer.

9. An emulsion as claimed in claim 8 wherein the plasticizer is one or more alkoxylated fatty alcohols, particularly C_{B} to C₂₀, more particularly C₁₀ to C₁₈, fatty alcohol 1 to 20, particularly 2 to 15, especially 3 to 12 alkoxylates, especially ethoxylates; alkoxylated fatty amines, particularly C₈ to C₂₀, more particularly C₁₀ to C₁₈, fatty amine 2 to 30, particularly 5 to 30, alkoxylates, especially ethoxylates, alkoxylated fatty acids particularly C₈ to C₂₀, more particularly C₁₀ to C₁₈, fatty acid 1 to 20, particularly 2 to 15, especially 3 to 12 alkoxylates especially ethoxylates; partial esters, of sorbitan, sorbitol, glycerol and similar polyols; fatty acid amides, particularly C₈ to C₂₀, more particularly C₁₀ to C₁₈, fatty acid amide surfactants, particularly alkanolamides; anionic or cationic surfactants, particularly sulfosuccinates, phosphate esters and/or cationic surfactants such as imidazoline surfactants, or quaternary fatty amine alkoxylates, particularly N-fatty alkyl, N-lower alkyl, di(polyalkyleneoxy)quaternary amines, more particularly where the fatty alkyl group is a C₈ to C₂₀, more particularly C₁₀ to C₁₈, fatty alkyl. the lower alkyl group is a C₁ to C₄, particularly a methyl or ethyl, group and the polyalkyleneoxy groups are 1 to 20, particularly 2 to 15, alkoxylates, or mixtures of two or more types of these.

10. An emulsion as claimed in claim 9 wherein the amount of plasticiser used is typically from 0.01 to 15%, more usually 0.05 to 10,% particularly 0.1 to 5%, by weight based on the oil phase.

11. An emulsion as claimed in claim 1 wherein the oil is one or more hydrocarbon oil and/or one or more ester oil.

12. An emulsion as claimed in claim 11 wherein the hydrocarbon oil is one or more of toluene, xylene, liquid paraffin, (iso)-paraffinic oil and/or aromatic mineral oils; and the ester oil is one or more of esters of C₂ to C₃₀ linear, branched or unsaturated fatty acids and linear, branched or unsaturated fatty alcohols; esters of di- or tri-carboxylic acid(s) with monohydric alcohol(s); esters of di- or poly-hydric alcohol(s) with monocarboxylic acid(s); methylated natural triglyceride oils; and/or aromatic ester oils.

13. An emulsion as claimed in claim 1 wherein the internal phase is an aqueous solution of at lest one of homopolymers and co-polymers of acrylamide, acrylic acid, acrylic acid salts, 2-acrylamido-2-methylpropane sulfonic acid, which may include as co-monomers one or more of allyl amine, dimethylaminoethylmethacrylate, or other ethylenically unsaturated monomers.

14. An emulsion as claimed in claim 1 wherein the concentration of the water soluble polymer is from 20 to 70%, particularly from 30 to 50%, by weight of the internal phase.

15. An emulsion as claimed in claim 1 wherein the internal phase forms from 30 to 75%, particularly from 50 to 70%, by volume of the overall emulsion.

16. An emulsion as claimed in claim 1 which additionally includes one or more of oils soluble surfactants and/or water in oil emulsifiers and/or water soluble surfactants and/or water in oil emulsifiers.

17. A method of forming a solution of a water soluble polymer in water which comprises diluting an inverse emulsion as claimed in claim 1 in water so that the inverse emulsion inverts and the water soluble polymer dissolves or disperses in the dilution water.
